(19) United States
(12) Patent Application Publication
(10) Pub. No.: US 2026/0012285 A1
(43) Pub. Date: Jan. 8, 2026

(54) METHOD AND SYSTEM FOR DETERMINING POTENTIAL ERROR SOURCE FOR TWO-SIDED MODELS

(71) Applicant: Lenovo (Singapore) Pte Limited, Singapore (SG)

(72) Inventors: Vahid POURAHMADI, Munchen (DE); Vijay Nangia, Woodridge, IL (US); Venkata Srinivas Kothapalli, Ottawa (CA); Ahmed Hindy, Aurora, IL (US)

(21) Appl. No.: 18/766,491

(22) Filed: Jul. 8, 2024

(51) Int. Cl. H04L 1/00; H04L 1/20; H04W 28/04

(52) U.S. Cl. CPC H04L 1/0033; H04L 1/0036; H04L 1/16

(57) ABSTRACT

Various aspects of the present disclosure relate to a UE comprising at least one memory and at least one processor coupled with the at least one memory and configured to cause the UE to implement a first encoder of a two-sided model trained by a set of reference samples, determine, using a first set of information and at least one of the first encoder or input data, at least one possible source of error associated with the two-sided model, and transmit a message indicating the at least one possible source of error to a network entity.

### TECHNICAL FIELD

The present disclosure relates to wireless communications, and more specifically to identifying a possible source of error in a two-sided model.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further include a UE for wireless communication with at least one memory and at least one processor coupled with the at least one memory and configured to cause the UE to implement a first encoder of a two-sided model that has been trained by a set of reference samples, determine, using a first set of information and at least one of the first encoder or input data, at least one possible source of error associated with the two-sided model, and transmit a message indicating the at least one possible source of error to a network entity. The first set of information may include at least one of a subset of a set of reference samples used to train the first encoder, the subset of the set reference samples used to train the first encoder and a corresponding latent representation generated by a reference encoder, a set of information regarding a decoder associated with the first encoder, and a set of information regarding a reference encoder.

In some implementations of the method and apparatuses described herein, the at least one processor is further configured to cause the UE to receive the first set of information from the network entity.

In some implementations of the method and apparatuses described herein, the at least one processor is further configured to cause the UE to measure a radio channel, and the input data is associated with the measurement of the radio channel.

In some implementations of the method and apparatuses described herein, the input data comprises at least one of a measured channel matrix of the radio channel and a precoder for the radio channel.

In some implementations of the method and apparatuses described herein, the at least one processor is further configured to cause the UE to transmit a request for the first set of information to the network entity based on an event triggered at the UE.

In some implementations of the method and apparatuses described herein, the first set of information further comprises at least one of a threshold value for determining the at least one possible source of error, and instructions for transmitting the message indicating the at least one possible source of error to the network entity.

In some implementations of the method and apparatuses described herein, the instructions for transmitting the message indicating the at least one possible source of error to the network entity comprise instructions for transmitting at least one of only the possible sources of error, a probability value associated with one or more possible source of error, and a similarity metric associated with one or more possible source of error.

In some implementations of the method and apparatuses described herein, the message indicating the at least one possible source of error comprises at least one identifier representing a respective possible source of error.

In some implementations of the method and apparatuses described herein, the at least one possible source of error indicated by the message comprises at least one of the first encoder, a first decoder of the two-sided model, a communication link between the UE and the network entity, and data shift of the two-sided model.

In some implementations of the method and apparatuses described herein, the message indicating the at least one possible source of error further comprises at least one of a probability that the at least one possible source of error is the source of error, and a similarity metric computed based on the first set of information received from the network entity.

Some implementations of the method and apparatuses described herein may further include a UE for wireless communication with at least one memory and at least one processor coupled with the at least one memory and configured to cause the UE to implement a first encoder of a two-sided model that has been trained by a set of reference samples, receive a first set of information comprising a set of test samples where the set of test samples are based on a subset of the set of reference samples used to train the first encoder from the network entity, encode the set of test samples using the first encoder to create encoded data, and transmit the second encoded data to the network entity.

### BRIEF DESCRIPTION OF THE DRAWINGS

FIG. 1 illustrates an example of a wireless communications system in accordance with aspects of the present disclosure.

FIGS. 2, 3, 4, 5, 6, 7, 8, and 9 illustrate examples of two-sided models in accordance with aspects of the present disclosure.

FIG. 10 illustrates an example of a user equipment (UE) 1000 in accordance with aspects of the present disclosure.

FIG. 11 illustrates an example of a processor 1100 in accordance with aspects of the present disclosure.

FIG. 12 illustrates an example of a network equipment (NE) 1200 in accordance with aspects of the present disclosure.

FIG. 13 illustrates a flowchart of a method performed by a UE or NE in accordance with aspects of the present disclosure.

FIG. 14 illustrates a flowchart of another method performed by a UE or NE in accordance with aspects of the present disclosure.

### DETAILED DESCRIPTION

Embodiments of the present disclosure relate to two-sided models trained by machine learning in a wireless network environment, and more specifically, to monitoring for and identifying possible sources or errors in a two-sided model implemented by wireless network devices.

Several schemes have been previously identified for monitoring two-sided models.

A first group of methods are usually referred to as network (NW)-side monitoring, or second node monitoring. In these methods, the idea is that the expected output, which is known at a first node, is also sent to a second node, so the second node can compare the expected output and the actual output to determine the performance of the model.

A second group of methods are usually referred to as UE-side monitoring, or first node monitoring. There are different schemes for UE-based monitoring, including estimation of what would be the model output, estimation of intermediate key performance indicators (KPI) or other monitoring metrics, and indication of the model actual output from the second node to the first node so the first node can compare the expected output and the actual output to determine the performance of the model.

Each of these options have different implications on overhead, latency, complexity, monitoring accuracy and UE capability but still they are aimed at determining if the model is working properly. If the conventional approaches determine that the model is not performing correctly, they are not able to efficiently give further information on why the model has lower performance.

In contrast, embodiments of the present disclosure provide additional assistance (or cause) information that can be used for determining possible reasons for the lower performance of a two-sided model.

Aspects of the present disclosure are described in the context of a wireless communications system.

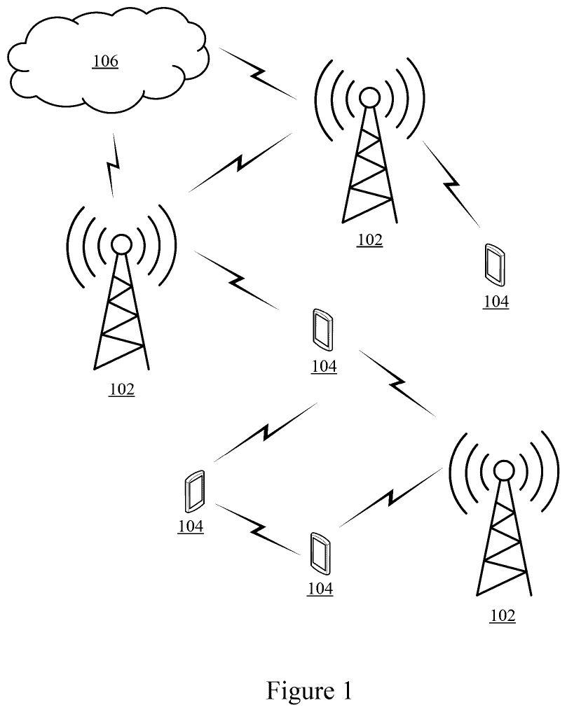

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

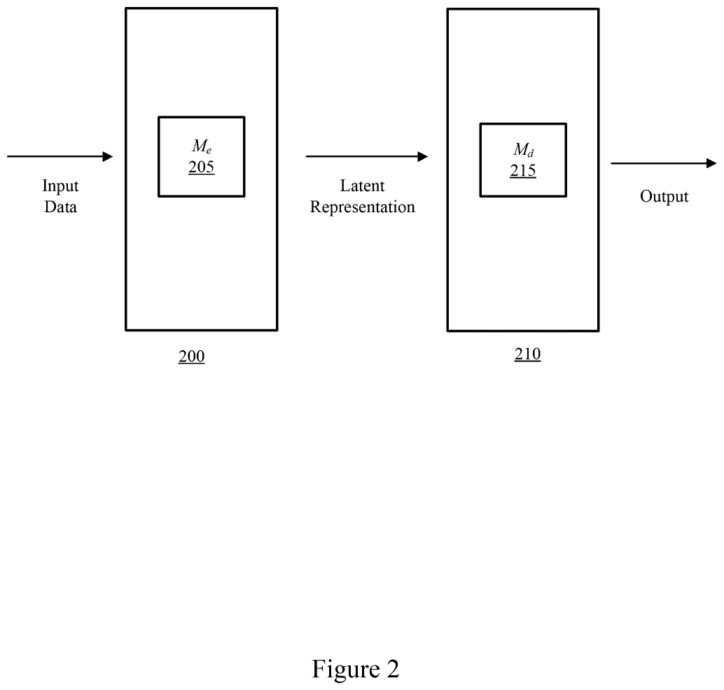

FIG. 2 illustrates an example of a two-sided model employed by a first node 200 and a second node 210 in accordance with aspects of the present disclosure. The first node 200 may correspond to a UE 102 and the second node 210 may correspond to the NE 102 (e.g. a gNB) described above.

In a typical wireless network in which a gNB is equipped with M antennas and is in communication with K UEs denoted by UE₁, UE₂, . . . , UE_{K} each UE may have N antennas.

$${H}_{l}^{k} ( t )$$

denotes the channel at time t over frequency band l, l∈{1, 2, . . . , L}, between the gNB and Uₖ which is a matrix of size N×M with complex entries, i.e.,

$${H}_{l}^{k} ( t ) ∈ {ℂ}^{N \times M} .$$

At time t and frequency band l, the gNB may transmit a message

$${x}_{l}^{k} ( t )$$

to user Uₖ where k={1, 2, . . . , K} while it uses wₗ^{k}(t)∈ [symbol] ^{M×1} as the precoding vector. The received signal at

$${U}_{k} , {y}_{l}^{k} ( t ) ,$$

can be written as:

$${y}_{l}^{k} ( t ) = {H}_{l}^{k} ( t ) {w}_{l}^{k} ( t ) {x}_{l}^{k} ( t ) + {n}_{l}^{k} ( t )$$

where

$${n}_{l}^{k} ( i )$$

represents the noise vector at the receiver.

To improve the achievable rate of the link, the gNB selects

$${w}_{l}^{k} ( t )$$

that maximizes the received signal to noise ratio (SNR) and may minimize interference for other users. Several schemes have been proposed for good selection of

$${w}_{l}^{k} ( t ) ,$$

most of which rely on having some knowledge about

$${H}_{l}^{k} ( t ) .$$

The gNB can obtain knowledge of

$${H}_{l}^{k} ( t )$$

by direct measurement (e.g., in time division duplexing (TDD) mode and assuming reciprocity of the channel), or indirectly using information that the UE sends to the gNB (e.g., in frequency division duplexing (FDD) mode). In the latter case, a large amount of feedback may be used to send accurate information about

$${H}_{l}^{k} ( t ) .$$

This becomes particularly important if there are a large number of antennas and/or large frequency bands.

For simplicity in description, we consider only a single time slot, but the proposed scheme can be further extended to the cases with more than a single time slot. Without loss of generality, therefore,

$${H}_{l}^{k} ( t )$$

is simply denoted using

$${H}_{l}^{k} .$$

H^{k}(t) may be defined as matrix of size N×M×L composed by stacking

$${H}_{l}^{k}$$

for all frequency bands, such that the entries at H^{k}[n, m, l](t) is equal to

$${H}_{l}^{k} [ n , m ] ( t ) .$$

In total, therefore, each UE is feeding back the information about the most recent N×M×L complex numbers to the gNB.

To reduce the rate of feedback transmitted to the gNB, a two-sided model may be used. A two-sided model is a scheme based on machine learning that has two parts (models) in which the first part, or encoder 205, is deployed at a first node 200 and the second part, or decoder 215, is deployed at the second node 210. The first node 200 and second node 210 may have of one or more neural network (NN) blocks which are trained using data driven approaches. The first node 200 is responsible for computing a latent/encoded representation of input data (to be transferred to the second node) with as low number of bits as possible using the encoder 205. Receiving the latent/encoded representation, the second node 210 reconstructs the input data using the decoder 215. Accordingly, the two-sided model may be used to compress and decompress data for efficient data transmission from a first node 200 to a second node 210.

In some embodiments, the input data could be data which is based on the channel measurements. For example, the input data could be the raw channel inputs of H^{k} or Hₗ^{k}, channel state information (CSI), or precoders that are computed from the channel matrix, e.g., the eigenvector associated to the largest eigen-vector of H^{k} for each subband. However, embodiments are not limited to channel data. In other embodiments, the input data could be user data such as video or voice data, or other types of data which are encoded and decoded by a two-sided model within a wireless network.

FIG. 2 depicts a high-level structure of a two-sided model with an NN-based first node 200 (e.g., UE) and second node 210 (e.g., gNB) referred to here as Mₑ 205 (encoding model or encoder) and M_{d} 215 (decoding model or decoder), respectively.

The exact structure of the first node 200 and second node 210 side can vary depending on the particular two-sided scheme. There also several possible schemes to train the encoder and decoder models 205 and 215, including simultaneous training and separate training. The applicability of a trained model is typically limited to the type of data it has observed during the training stage for the model to perform effectively. If the model is provided with an input which is very different from the statistics of the training dataset, it may result in lower performance.

One important stage in applying machine learning models is to monitor the performance of the current model. For example, when an encoder/decoder pair has been trained for a certain task and it has been confirmed that the performance of this pair in the training node is higher than a minimum requirement of the system, the trained model is then ready for deployment at the first node 200 and the second node 210.

After deployment, a confirmation stage may be performed to confirm that the deployed model also performs correctly during the actual inference stage using input data other than the training/test/validation dataset used to train the model. This stage may be referred to as the monitoring stage. There are several possible schemes for model monitoring, for example, UE-sided model monitoring, network-sided model monitoring, and input based monitoring.

Embodiments of the present disclosure are different from conventional model monitoring and may be performed in parallel with conventional model monitoring. Rather, embodiments of the present disclosure determine possible sources of error in a two-sided model. While model monitoring may identify that a deployed model is not providing an expected level of performance, model monitoring is not capable of identifying the source or reason of the performance deficiency. Accordingly, some embodiments may be implemented after a monitoring scheme has determined that the model is performing worse than expected, e.g. below a performance metric threshold. As will be explained in more detail below, information provided by embodiments of the present disclosure may include one or more potential source of error as well as other information which can be used by a first node 200, a second node 210, or both, to determine a source of error and efficiently resolve the error.

Returning to FIG. 2, a two-sided model comprising an encoder 205 and a decoder 215 is deployed in a network. The encoder 205 is deployed at first node 200 and the decoder 215 is deployed at second node 210. The first node 200 uses encoder Mₑ 205 to encode input data xᵢ and transmits the encoded data or latent representation zᵢ=Mₑ(xᵢ), through the channel H. The second node 210 receives the encoded data and decodes the received message yᵢ using decoder M_{d} 215 and determines the output Oᵢ=M_{d}(yᵢ). In some examples, the received message yᵢ may be pre-processed e.g., by channel equalization, detection, and/or error-correction/detection channel decoding.

The first node 200 may be a UE 102 and the second node 210 may be a NE 104. In other embodiments, the roles of the UE 102 and NE 104 are reversed with a two-sided model such that the encoder Mₑ 205 is deployed at an NE 104 and the decoder M_{d} is deployed at a UE 102. Accordingly, the first node 200 may be an NE 104 (e.g. a gNB) and the second node 210 may be a UE 102. In some embodiments, each of the first node 200 and second node 210 may comprise both an encoder 205 and a decoder 215 to handle both uplink and downlink communications.

A process for determining a possible source of error associated with a two-sided model may be initiated in various ways. For example, it may be configured by the network, may be started automatically after each monitoring step which shows lower than expected performance, may be implemented along with a monitoring step, or may be initiated after receiving and indication from another device.

In some embodiments, the process may be initiated based on one or more indication from the second node 210. For example, the second node 210 may be unable to decode received messages y; and transmit NACK messages to the first node 200. In this scenario, the first node 200 may initiate a process for determining a possible source of error when an amount of NACK messages received within a time period exceeds a threshold, or when a number of NACK messages exceeds a threshold value with respect to the number of associated transmissions (e.g. a percentage of latent representations result in NACKs). In another embodiment, the second node 210 may independently determine possible issues with the two-sided model and transmit an indication that triggers a process for determining a possible source of error.

In addition, implementation of the monitoring step, as well as the specific process used, may be use-case dependent. For example, it may be based on the similarity (e.g., Euclidean distance or cosine similarity) of the output of the decoder model and the expected output, based on the throughput of the system, a number of NACK messages received at a UE, a number of retransmissions within a time period, etc. Each of these (as well as events described in the foregoing paragraphs) may be referred to as events triggered at the first node 200, to which the UE responds by transmitting a request for a first set of information to the second node 210.

In other embodiments, a process for determining a possible source of error may be performed on a periodic or ongoing basis. For example, the second node 210 may transmit an indication that triggers a process for determining a possible source of error to the first node 200 on a periodic basis, or the first node 200 may implement the process on a periodic basis.

A process for determining a possible source of error may be initiated when a two-sided model is first implemented, or for two-sided models which are already in use. In some embodiments, the process is initiated when monitoring indicates less than expected performance, e.g. performance metrics that are less than a threshold value.

There are at least three possible sources of error associated with a two-sided model that may be identified by embodiments of the present disclosure.

A first possible source of error is deployment of one or both of the encoder model 205 and the decoder model 215. If the deployment is the source of error, the original trained models may perform correctly for input data, and a problem is associated with the deployment of one or both of the models at the respective nodes.

Examples include malfunctioning of either of the deployed encoder 205 or decoder 215 during run-time environment, or a difference between the deployed encoder or decoder and the original trained encoder/decoder. These errors could occur due to further on-device or offline optimization, development or retraining (e.g., quantization of the model parameters, intermediate layer outputs, final output) or corruption. Another example is the incorrect deployment of the encoder or decoder model at a device, e.g. an error related to the installation of a model at a node, deployment of an incorrect model, etc.

A second possible source of error may be referred to as data shift. Data shift refers to a situation in which the current input data (during the inference phase) has different statistics from the data used for training of the two-sided model. Data shift may represent a shift in input data distribution compared to refence samples used for training. Data shift may be the most common source of error.

Data shift is likely to be present when a trained and deployed model is not capable of handling the current input data, even though the model may have acceptable performance for some other input data, e.g. the training data. Accordingly, data shift may be present when a two-sided model is not well trained for the input data which is subsequently processed by the model. Data shift may be due to insufficient samples in the training dataset with statistics similar to the statistics of the current input data.

A third possible source of error is a communication link between the first node 200 and the second node 210. Such errors occur when transferring encoded data to the second node 210, and could relate to a noisy channel, bit erasure, message erasure, etc. such that the transmitted data is not correctly received by the second node 210.

When the communication link is a source of error, there are errors in the received message yᵢ compared to transmitted message zᵢ which may result in incorrect functioning of a two-sided model. If PHY layer error detection schemes are available, they could be used as another scheme to determine the cause of the lower performance. Accordingly, existing schemes for detecting and correcting communication links may be used in conjunction with embodiments and may be used to supplement a process for determining a possible source of error.

The following embodiments present different schemes for detecting a possible source of error in a two-sided model. In these embodiments, the second node 210, e.g. a NE 104, may have access to a version of the encoder model 205, e.g. a network-side encoder model. The network-side encoder model may be trained in accordance with the trained decoder model 215, and therefore it can be considered as the correct encoder model for the deployed decoder model 215. The network-side encoder model may for example be constructed during the training of the decoder model based on NW-first Type-3 training.

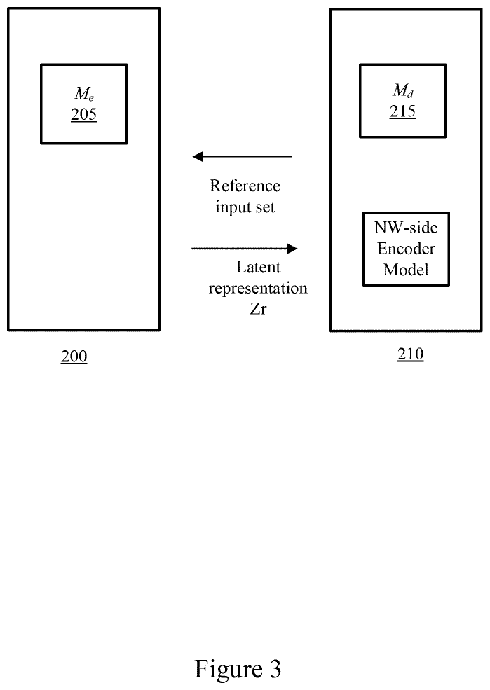

In a first embodiment, one or more possible source of error is identified by exchange of a reference input set. In particular, as illustrated in FIG. 3, the second node 210 may transmit a first set of information to the first node 200 comprising at least a subset of the set of reference samples used to train the encoder 205. In this embodiment, the second node 210 transmits, to the first node 200, a set of inputs xᵣ that are consistent with the data that has been used for training the decoder 210 and encoder 200. By using the training data as an input, the trained two-sided model should work correctly, and the expectation is that if the deployed encoder 200 is correctly tuned it will generate a latent output that can be correctly decoded by the deployed decoder 210.

After receiving the reference samples, the first node 200 determines the latent representation of received xᵣ, i.e., zᵣ, by providing the reference samples to the encoder 205 and transmits the resulting latent representation zᵣ to the second node 210. The second node 210 decodes zᵣ using the deployed decoder 210 to produce an output referred to as Ôᵣ. If the similarity between Ôᵣ and the correct expected output, Oᵣ, is less than a threshold value, the second node 210 may determine that the deployed encoder 205 is a possible source of error.

In addition, the second node 210 may determine that the communication link is a possible source of error which caused the received yr to be far from zᵣ (i.e., zᵣ cannot be correctly recovered from the received yᵣ), which resulted in lower-than-expected end to end performance. In this embodiment, when an error is detected in the output Ôᵣ, data shift may be foreclosed as a possible source of error since the reference samples are consistent with the data used for training the two-sided model. Accordingly, this embodiment may determine deployment and/or a communication link as a possible source of error.

It is possible that when the communication link is the source of error, the communication link may be disrupted at irregular intervals. Accordingly, when multiple iterations of the first embodiment are repeated and some iterations show an error in the output and some do not, it may be determined that the communication link is the source of error and not the deployment.

In addition, problems with the communication link can be detected for example using error control codes such as cyclic redundance check (CRC) error detection codes and error-correction codes such as LDPC and Polar code. The presence or absence of these codes may be used to determine whether a possible source of error is more likely to be the encoder 205 or the communication link. This information may be used in various embodiments of the present disclosure.

In an embodiment, the second node 210 may transmit reference samples to multiple first nodes 200 and compare the latent transmissions from the multiple nodes. As all latent representations should be decoded similarly, the second node 210 may determine a possible error in the encoder or the communication link of the first nodes 200 for which latent representations are different from the others, e.g., by using clustering mechanisms.

In another alternative, at least one of the first nodes 200 is a reference node and the second node 210 may compare the similarity between the feedback latent representations from a non-reference node and the feedback latent representations from the reference node. The reference node may be, for example, a UE that the network has knowledge of as having a correct encoder model (e.g., based on recent communication and/or successful model monitoring performance).

In another embodiment, as illustrated in FIG. 3, the second node 210 has access to a network-side encoder model. In this embodiment, the second node 210 can compare the latent representation from the first node 200 with the latent representation xᵣ generated by the network-side encoder model. If the similarity is less than a threshold value, the second node 210 may conclude that the deployed encoder 205 is a possible source of error.

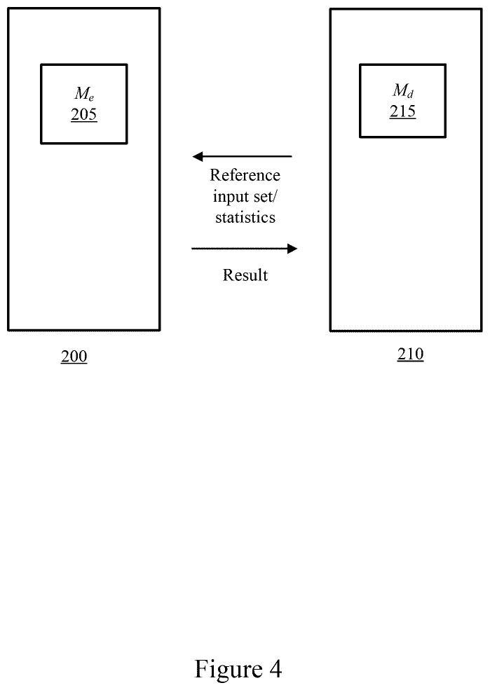

In a second aspect of the first embodiment, the first node 200 may compare statistics of a current input set with statistics of a reference input set. In this aspect, as illustrated in FIG. 4, the second node 210 transmits a set of reference inputs xᵣ that are consistent with the data that has been used for training of the deployed two-sided model, e.g. at least a subset of the set of reference samples used to train the two-sided model, to the first node 200.

The first node 200 may use the reference samples as a dataset representing the statistics of the data that has been used for training the two-sided model. During inference, the first node 200 may determine the statistical similarity value between this dataset and set of data collected under current conditions, e.g. non-reference data or current input data.

The first node 200 may compare the statistical similarity to a threshold value, and if the similarity value lower than the threshold, the first node 200 may determine that a data shift error is present and transmit a message to the second node 210 indicating data shift as the source of error. In some embodiments, the first node 200 may indicate data shift as a possible source of error along with at least one other possible source of error depending, for example, on other metrics or the magnitude of the difference in statistics.

In another example, the second node 210 transmits statistics, or a representation of statistics (e.g., distribution, parameterization of the distribution, principal components, etc.), of the set of reference samples to the first node 200. The first node 200 may then determine the statistical similarity between the received statistics and the set of data collected under the current conditions during inference and determine if there is a distribution shift, e.g. the similarity metric is lower than a threshold, and transmit an indication of a result of the determination to the second node 210 as shown in FIG. 4.

In some examples, the second node 210 may transmit to the first node 200 an indication of the similarity metric and/or threshold value for the first node 200 to use.

In another example, the second node 210 may transmit to the first node 200 a method, algorithm or model that the first node 200 can use to determine similarity between the statistics of the set of data collected under the current conditions during inference, and the statistics (or a representation thereof) of the reference input (e.g., training dataset) set and determine if there is a distribution shift e.g., the similarity metric is lower than a threshold, and indicate a result the second node 210. For example, the model itself could be another neural network trained for outlier detection.

In some examples, a size of the set of inputs xᵣ is bounded by a minimum value such that the size of the set of inputs xᵣ is no smaller than a threshold. In another example, the size of the set of inputs xᵣ may depend on, or be a function of, a confidence threshold associated with a precision metric. In yet another example, a value of the confidence threshold may be based on the size of the set of inputs xᵣ.

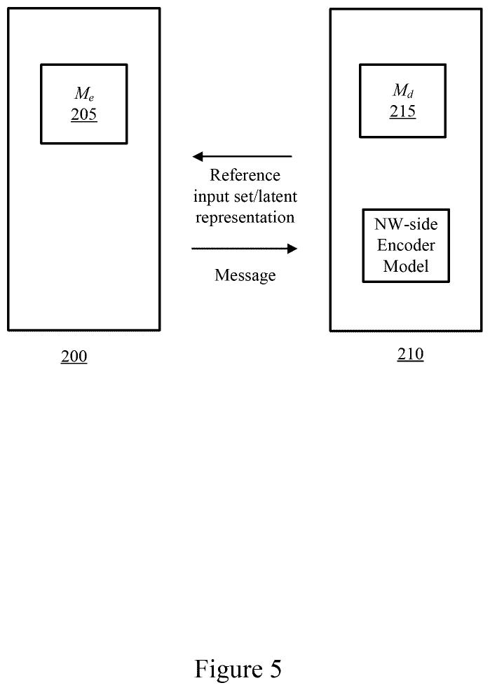

In a second embodiment, one or more possible source of error is identified using the exchange of a reference input set and their corresponding reference latent representation. In this embodiment, a second node 210 has access to a network-side encoder model as seen in FIG. 5. Similar to the first embodiment, the second node 210 transmits a set of inputs X that are consistent with data that has been used for training the two-sided model to the first node 200. In addition, the second node 210 transmits information related to the latent representation of the inputs xᵣ generated by the NW-side-encoder-model to the first node 200. Accordingly, the second node 210 transmits a first set of information comprising a subset of the set reference samples used to train the encoder 205 and its corresponding latent representation generated by a reference encoder.

The first node 200 uses its deployed encoder 205 to generate an encoded message for xᵣ, that is zᵣ. The first node 200 can then compare the similarity between the zᵣ and the set of latent representations received from the second node 210. When the first node 200 determines that a similarity value is lower than a threshold, the first node 200 may determine that the deployed encoder model is a source of error or at least one possible source of error and transmit a corresponding indication to the second node 210.

In various embodiments, the first node 200 may transmit, to the second node 210, one or more of a) a message indicating a problem with the encoder 205 (or in general a module), b) a probability or in general a real-valued number representing a confidence level associated with the determination that there is an issue with the deployed encoder (or in general a module), and c) the resulting similarity metric. The first node may transmit the similarity metric by itself to the second node 210 and the second node 210 may determine whether the encoder 205 is a possible source of error. In other words, the first node 200 may transmit one or more of a determination, a probability, a confidence, and a similarity metric to the second node 210.

One or more of these data may be transmitted to the second node 210 along with data associated with other embodiments, and more generally, it should be recognized that the various embodiments are not exclusive and can be combined in some implementations to more accurately identify a source of error.

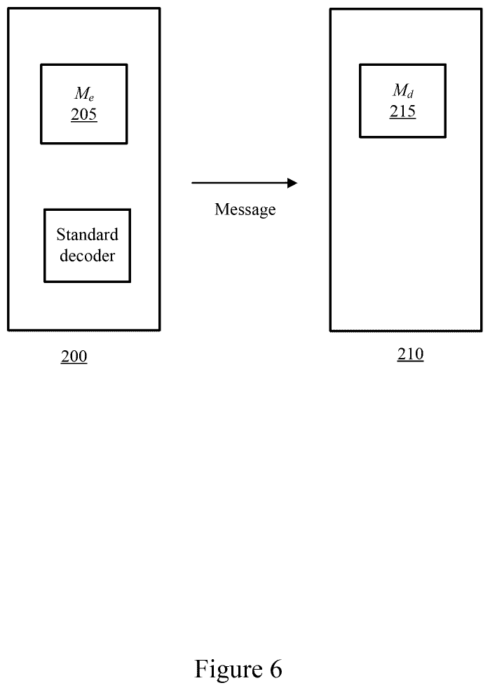

In a third embodiment, as illustrated by FIG. 6, one or more possible source of error is identified using a standard decoder at the first node 200, e.g. a decoder that is designed and used for testing. A standard decoder may be developed and/or specified by an independent body such as 3GPP. In some instances, the trained encoder 205 is confirmed to operate satisfactorily with the standard decoder, e.g., during performance and/or conformance testing of the first node 200. As one example, in 3GPP this decoder may be designed and specified by RAN4 and all encoders may be tested against this standard decoder before they can deployed in associated nodes.

If there is a flag or an indication to start the process of determining the possible source of error, the first node 200 may construct a test two-sided test model comprising the deployed encoder 205 and the standard decoder. The standard decoder may be stored at the first node 200 or transmitted from the second node 210 to the first node 200.

The first node 200 may provide input data to the two-sided test model and determine a similarity metric between the output from the test model and an expected output. The expected output may be stored at or received by the first node 200 along with the standard decoder.

If the similarity between the expected output and the output of the standard decoder is higher than a threshold, the first node 200 may determine that there an issue with the deployed decoder 210 or the communication link. The first node 200 may then transmit this information in a message to the second node 210. In some examples, the communication link may be indicated as a possible source of error if issues with the communication link are not detectable by other techniques (e.g., error-correction and/or detection coding used in the communication between the first node 200 and second node 210).

In this embodiment, if the first node 200 further has access to reference inputs as discussed with respect to the first embodiment (different from the current input), then the first node 200 can check the test two-sided model with the reference inputs. If the similarity from this test is low (e.g., between the expected output and the output of the standard decoder based on the reference inputs is higher than a threshold), the first node 200 may conclude and report the deployed decoder 215 as a possible source of error; otherwise, the possible source of error may be in the communication link. Accordingly, the first node 200 may transmit to the second node 210 a message indicating that one or both of the decoder 215 and the communication link are a possible source of error.

If the similarity metric from testing the standard decoder is less than a threshold, the first node 200 may determine that there an issue with the deployed encoder 205 or data shift is present. The first node 200 may then transmit this information in a message to the second node 210. In this case, if the first node 200 further has access to reference inputs as discussed with respect to the first embodiment (different from the current input), then the first node 200 may run the two-sided test model with these reference inputs. If a resulting similarity value is low, the first node 200 may conclude and report a possible issue with the deployed encoder 205; otherwise, the issue may a data shift error. The first node 200 may determine if the issue is due to data or distribution shift by comparing the statistics of a current input set with the statistics of a reference input set as described above.

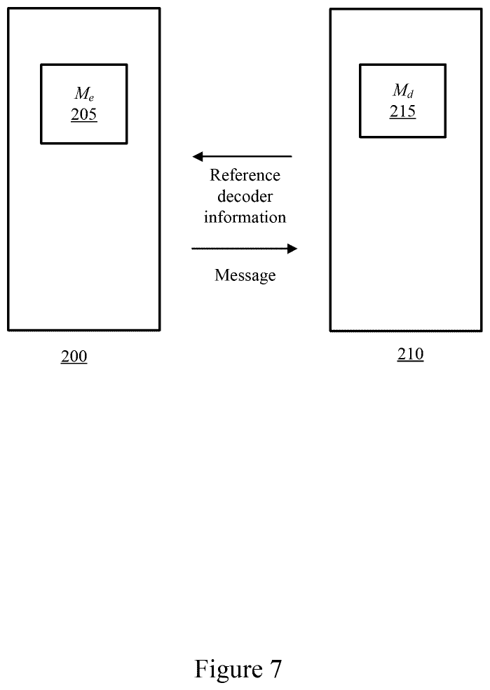

In a fourth embodiment, one or more possible source of error is identified using reference decoder information. In this embodiment, the first node 200 may receive reference decoder information from the second node 210 and construct a two-sided model including a reference decoder locally at the first node 200 as seen in FIG. 7.

The second node 210 may transmit a set of information regarding a reference decoder to the first node 200. The reference decoder may represent the deployed decoder 215 at the second node 210. In various embodiments, the set of information regarding a reference decoder may be the decoder 215 that is deployed at the second node 210, a trained decoder, samples representing the decoder 215, or another model based on the trained decoder or deployed decoder 215.

Having this model, if there is a flag or an indication to start the process of determining the possible source of error, then the first node 200 may construct a test two-sided model using the deployed encoder 205 and the reference decoder. The first node may then use the test model in a similar fashion to the third embodiment discussed above. The reference model may be transmitted after or along with the indication to start the process of determining the possible source of error.

For example, the first node 200 may provide the local two-sided model with the current input data, and if the similarity between the expected output and the output of the reference decoder is higher than a threshold, the first node 200 may determine that the deployed decoder 215 or the communication link are possible sources of error. The first node 200 may transmit this information in a message to the second node 210.

If the similarity is less than a threshold, the first node 200 may determine that the deployed encoder 205 or data shift are possible sources of error. The first node 200 may then transmit this information in a message to the second node 210.

In this case, if the first node 200 further has access to some reference inputs similar to the first embodiment (different from the current input), then it can check the test two-sided model with these reference inputs. The reference inputs may be further received from node 210. If the similarity is low, the first node 200 may determine the deployed encoder 205 is the source of error or a possible source of error. Otherwise, the first node 200 may determine data shift is the source of error or a possible source of error and transmit this information in a message to the second node 210.

If the first node 200 further has access to a reference encoder (representing a network-side encoder model), it can construct a second test two-sided model composed of the reference encoder and the reference decoder by providing the second test two-sided model with the current input and comparing the output with the expected output. This reference encoder may be further received from node 210. If the similarity is high, the first node 200 may identify the deployed encoder 205 as a source of error, otherwise, the first node 200 may identify data shift as a possible source of error.

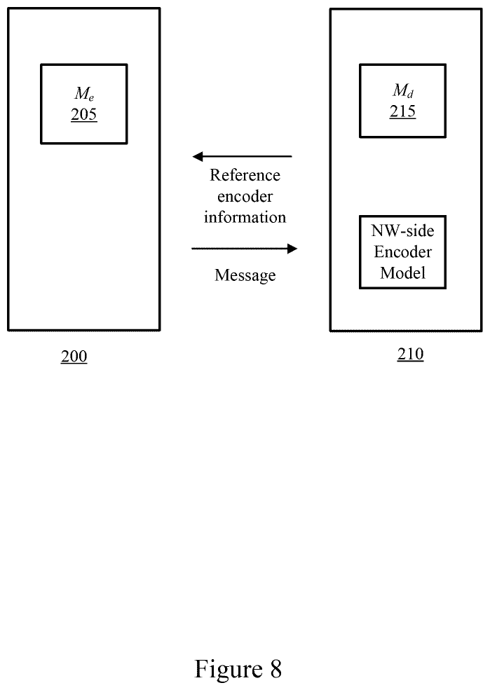

In a fifth embodiment, one or more possible source of error is identified using reference encoder information. As seen in FIG. 8, The second node 210 may transmit information regarding the reference encoder to the first node 200 so that the first node 200 can construct the reference encoder. The reference encoder may represent the network-side encoder model. The reference encoder may be exactly the network-side encoder model, or another model based on the network-side encoder model. In some examples, the reference encoder may be a standard encoder model (e.g., an encoder that is designed by RAN4 and used for testing).

Having the reference encoder, if there is flag or indication to start the process of determining the possible source of error, then the first node 200 may feed a current input to the reference encoder. If the similarity between the output from the reference encoder and the output of the deployed encoder 205 is high, then the first node 200 may determine that the deployed decoder 215 or communication link are possible sources of error and transmit this information in a message to the second node 210.

The first node 200 may also have a reference decoder as described above. In this case, the first node 200 may construct a test two-sided model composed of the deployed encoder 205 and the reference decoder, feed the test two-sided model with the current input and compare the output with the expected output. If the similarity is high, the first node 200 may determine the communication link is the source of error or a possible source of error, and if the similarity is low, the first node 200 may determine the deployed decoder 215 is the source of error or a possible source of error.

If the similarity between the output of the reference encoder and the output of the deployed encoder 205 is low, then the first node 200 may determine that the possible source of error is the deployed encoder 205 or data shift and report this information to the second node 210.

In this case, if the first node 200 further has access to reference inputs as discussed with respect to the first embodiment (different from the current input), then it can compare the output of the deployed and reference encoders using the reference input. If the similarity is low, the first node 200 may conclude that the deployed encoder 205 is a source of error or a possible source of error; otherwise, the first node 200 may conclude that data shift is a source of error or a possible source of error.

As described above, in various embodiments, the first node 200 may have one or more of a reference encoder, a reference decoder, and reference samples. The first node 200 may use one or all of these components to test model performance to identify a possible source of error with the deployed two-sided model comprising the encoder 205, the decoder 215 and the communication link between the first and second nodes 200 and 210.

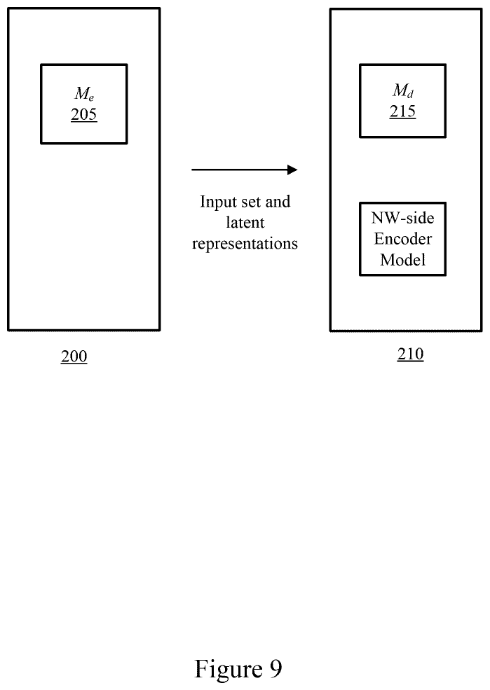

In a sixth embodiment, one or more possible source of error is identified using an inference input set and corresponding latent representations from the first node 200. In this embodiment, the second node 210 may have access to a network-side encoder model. As seen in FIG. 9, The first node 200 may transmit an inference input set and corresponding latent representations to the second node 210. The second node 210 may then compare the received latent representation with the latent representation of the inference input set generated by the network-side encoder model.

If the similarity between the received data and the data generated by the second node 210 is less than a threshold, the second node 210 can conclude that the deployed encoder 205, communication link or data shift are possible sources of error. The second node 210 may also compare the statistics of the inference input set with the statistics of the data that has been used for training the decoder/encoder to determine the statistical similarity. If the statistical similarity is lower than a threshold, the second node 210 may conclude that there may be a data shift issue.

In the embodiments described above, the first node 200 may transmit a message to the second node 210 which includes multiple components which represent possible sources of error and information related to each component. The information for each component may indicate that the component is not operating as expected, a probability that the component is a source of error, a similarity metric (as discussed above), etc. For example, the message may comprise one or more number between 0 and 1 for each possible source of error, each of which represents a probability that there is a problem in the deployed encoder 205 or decoder 215, the communication link, and/or the statistics of the current input data is different from the data used during the training.

Even though the six embodiments of detecting possible sources of error in a two-sided model have been explained separately, two or more of the embodiments may be combined. When two or more embodiments are combined, the accuracy of error detection may be increased.

In some embodiments, the accuracy and confidence of detecting the similarity level of two sets of samples or the statistical similarity of two sets of samples may depend on the number of points used for this calculation. In some examples this number could be configured by the network, or a threshold may depend on the number of samples used.

The specific way that the similarity of two sets of vectors are determined may be based on the use-case. For example the similarity between set 1 of {a₁, a₂, . . . , aₙ} and the corresponding vectors set-2 of {b₁, b₂, . . . , bₙ} may be defined based on the average Euclidian distance between aᵢ and bᵢ, or may be based on the average cosine-similarity of between aᵢ and bᵢ. If the vectors of set-1 and set-2 do not have one-to-one correspondence, then the similarity of the two sets could be determined based on other approaches like Earth Mover's Distance, or Maximum Mean Discrepancy.

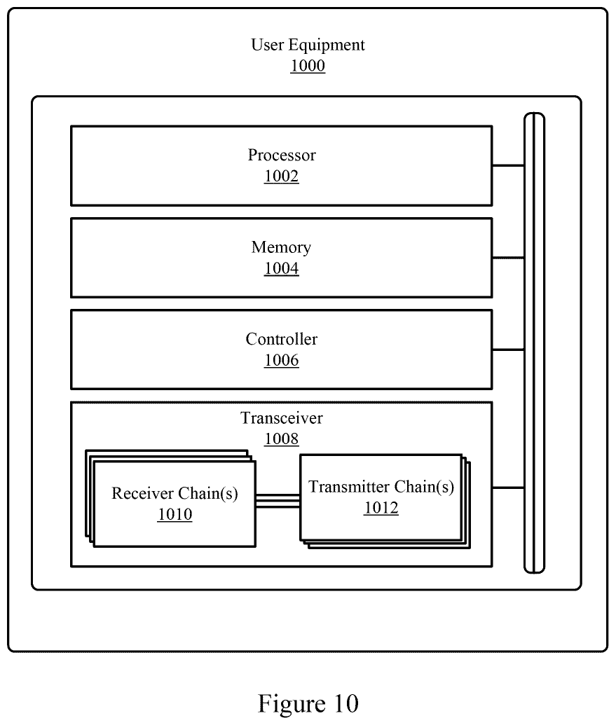

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to support a means for identifying a possible source of error in a two-sided model.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

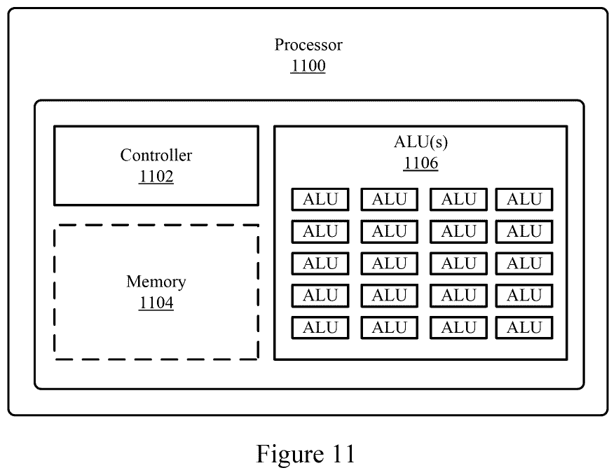

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support a means for identifying a possible source of error in a two-sided model.

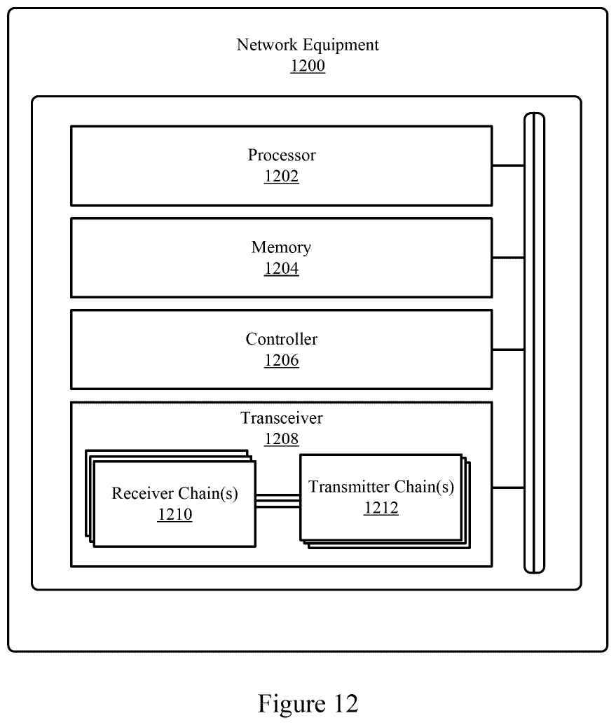

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to support a means for identifying a possible source of error in a two-sided model.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or a wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

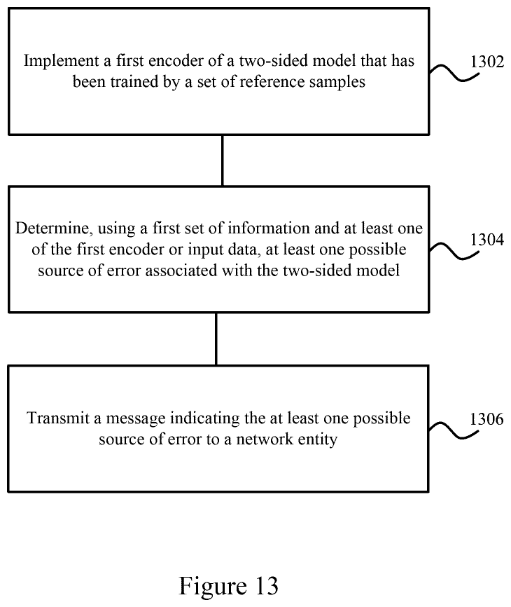

FIG. 13 illustrates a flowchart of a method in accordance with aspects of the present disclosure. The operations of the method may be implemented by a UE or NE as described herein. In some implementations, the UE or NE may execute a set of instructions to control the function elements of the UE or NE to perform the described functions.

At 1302, the method may include implementing a first encoder of a two-sided model that has been trained by a set of reference samples. The operations of 1302 may be performed in accordance with examples as described herein. In some implementations, aspects of the operations of 1302 may be performed by a UE as described with reference to FIG. 10 or a NE as described with reference to FIG. 12.

At 1304, the method may include determining, using a first set of information and at least one of the first encoder or input data, at least one possible source of error associated with the two-sided model. The operations of 1304 may be performed in accordance with examples as described herein. In some implementations, aspects of the operations of 1304 may be performed by a UE as described with reference to FIG. 10 or a NE as described with reference to FIG. 12.

In some embodiments, the first set of information comprises at least one of a subset of a set of reference samples used to train the first encoder, the subset of the set reference samples used to train the first encoder and a corresponding latent representation generated by a reference encoder, a set of information regarding a decoder associated with the first encoder, and a set of information regarding a reference encoder. The sets of information may comprise the decoder and the reference encoder, or a set of samples which represent the decoder and the reference encoder.

When a node (e.g. the second node 210) transmits information regarding the decoder or the reference encoder (e.g. network-side encoder model), it can send the information regarding the actual decoder model or the actual reference encoder model. In some embodiments, instead of the actual models, the second node 210 may transmit information regarding a second model which is created to have similar behavior of the actual model itself. Although this case may lead to some mismatch between the actual model and the second model, it may help with preserving information regarding the actual design and implementation of the model (since the first node 200 or second node 210 might not want to disclose their actual model implementation).

In addition, with respect to information regarding various models, the message may comprise one or more of: 1) the model structure and parameters (e.g., weight of the neural network), 2) a dataset using which the node can train the model 3), and when the model structure is known to the other node, the message may contain only the parameters of the model (e.g. the weight of the neural network).

At 1306, the method may include transmitting a message indicating the at least one possible source of error to a network entity. The operations of 1306 may be performed in accordance with examples as described herein. In some implementations, aspects of the operations of 1306 may be performed a UE as described with reference to FIG. 10 or a NE as described with reference to FIG. 12.

It should be noted that the method described herein describes a possible implementation, and that the operations and the steps may be rearranged or otherwise modified and that other implementations are possible.

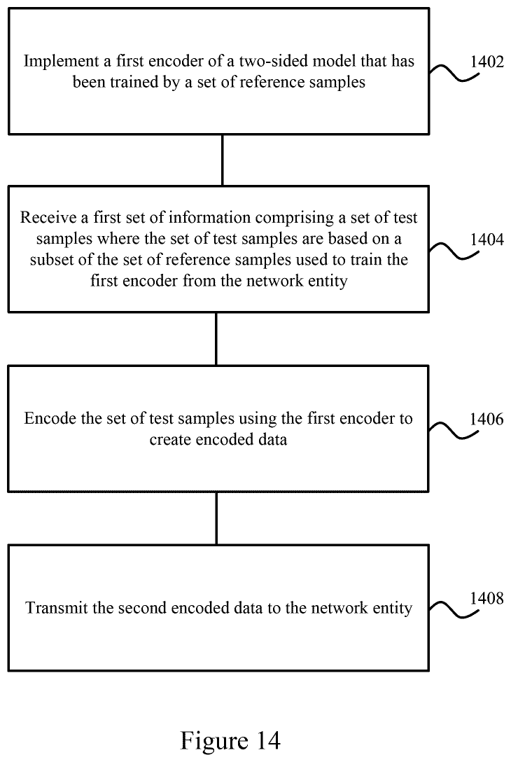

FIG. 14 illustrates a flowchart of a method in accordance with aspects of the present disclosure. The operations of the method may be implemented by a UE or NE as described herein. In some implementations, the UE or NE may execute a set of instructions to control the function elements of the UE or NE to perform the described functions.

At 1402, the method may include implementing a first encoder of a two-sided model that has been trained by a set of reference samples. The operations of 1402 may be performed in accordance with examples as described herein. In some implementations, aspects of the operations of 1402 may be performed by a UE as described with reference to FIG. 10 or a NE as described with reference to FIG. 12.

At 1404, the method may include receiving a first set of information comprising a set of test samples where the set of test samples are based on a subset of the set of reference samples used to train the first encoder from the network entity. The operations of 1404 may be performed in accordance with examples as described herein. In some implementations, aspects of the operations of 1404 may be performed by a UE as described with reference to FIG. 10 or a NE as described with reference to FIG. 12.

At 1406, the method may include encoding the set of test samples using the first encoder to create encoded data. The operations of 1406 may be performed in accordance with examples as described herein. In some implementations, aspects of the operations of 1406 may be performed by a UE as described with reference to FIG. 10 or a NE as described with reference to FIG. 12.

At 1408, the method may include transmitting the second encoded data to the network entity. The operations of 1408 may be performed in accordance with examples as described herein. In some implementations, aspects of the operations of 1408 may be performed by a UE as described with reference to FIG. 10 or a NE as described with reference to FIG. 12.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
implement a first encoder of a two-sided model that has been trained by a set of reference samples;
determine, using a first set of information and at least one of the first encoder or input data, at least one possible source of error associated with the two-sided model; and
transmit a message indicating the at least one possible source of error to a network entity,
wherein the first set of information comprises at least one of:
a subset of a set of reference samples used to train the first encoder,
the subset of the set reference samples used to train the first encoder and a corresponding latent representation generated by a reference encoder,
a set of information regarding a decoder associated with the first encoder, and
a set of information regarding a reference encoder.

2. The UE of claim 1, wherein the at least one processor is further configured to cause the UE to receive the first set of information from the network entity.

3. The UE of claim 1, wherein the at least one processor is further configured to cause the UE to measure a radio channel, and wherein the input data is associated with the measurement of the radio channel.

4. The UE of claim 3, wherein the input data comprises at least one of a measured channel matrix of the radio channel and a precoder for the radio channel.

5. The UE of claim 1, wherein the at least one processor is further configured to cause the UE to transmit a request for the first set of information to the network entity based on an event triggered at the UE.

6. The UE of claim 1, wherein the first set of information further comprises at least one of a threshold value for determining the at least one possible source of error, and instructions for transmitting the message indicating the at least one possible source of error to the network entity.

7. The UE of claim 6, wherein the instructions for transmitting the message indicating the at least one possible source of error to the network entity comprises instructions for transmitting at least one of only the possible sources of error, a probability value associated with one or more possible source of error, and a similarity metric associated with one or more possible source of error.

8. The UE of claim 1, wherein the message indicating the at least one possible source of error comprises at least one identifier representing a respective possible source of error.

9. The UE of claim 8, wherein the at least one possible source of error indicated by the message comprises at least one of:
the first encoder,
a first decoder of the two-sided model,
a communication link between the UE and the network entity, and
data shift of the two-sided model.

10. The UE of claim 8, wherein the message indicating the at least one possible source of error further comprises at least one of:
a probability that the at least one possible source of error is the source of error, and
a similarity metric computed based on the first set of information received from the network entity.

11. A processor for wireless communication, comprising:
at least one controller coupled with at least one memory and configured to cause the processor to:
implement a first encoder of a two-sided model that has been trained by a set of reference samples;
determine, using a first set of information and at least one of the first encoder or input data, at least one possible source of error associated with the two-sided model; and
transmit a message indicating the at least one possible source of error to a network entity,
wherein the first set of information comprises at least one of:
a subset of a set of reference samples used to train the first encoder,
the subset of the set reference samples used to train the first encoder and a corresponding latent representation generated by a reference encoder,
a set of information regarding a decoder associated with the first encoder, and
a set of information regarding a reference encoder.

12. The processor of claim 11, wherein the controller is further configured to cause the processor to receive the first set of information from the network entity.

13. The processor of claim 11, wherein the controller is further configured to cause the processor to measure a radio channel, and wherein the input data is associated with the measurement of the radio channel.

14. The processor of claim 13, wherein the input data comprises at least one of a measured channel matrix of the radio channel and a precoder for the radio channel.

15. The processor of claim 11, wherein the message indicating the at least one possible source of error comprises at least one identifier representing a respective possible source of error and at least one of:
the first encoder,
a first decoder of the two-sided model,
a communication link between the UE and the network entity, and
data shift of the two-sided model.

16. The processor of claim 11, wherein the message indicating the at least one possible source of error further comprises at least one of:
a probability that the at least one possible source of error is the source of error, and
a similarity metric computed based on the first set of information received from the network entity.

17. A method performed by a user equipment (UE), the method comprising:
implementing a first encoder of a two-sided model that has been trained by a set of reference samples;
determining, using a first set of information and at least one of the first encoder or input data, at least one possible source of error associated with the two-sided model; and
transmitting a message indicating the at least one possible source of error to a network entity,
wherein the first set of information comprises at least one of:
a subset of a set of reference samples used to train the first encoder,
the subset of the set reference samples used to train the first encoder and a corresponding latent representation generated by a reference encoder,
a set of information regarding a decoder associated with the first encoder, and
a set of information regarding a reference encoder.

18. A user equipment (UE) for wireless communication, comprising:
at least one memory; and
at least one processor coupled with the at least one memory and configured to cause the UE to:
implement a first encoder of a two-sided model that has been trained by a set of reference samples;
receive a first set of information comprising a set of test samples where the set of test samples are based on a subset of the set of reference samples used to train the first encoder from the network entity;
encode the set of test samples using the first encoder to create encoded data; and
transmit the second encoded data to the network entity.

19. The UE of claim 18, wherein the at least one processor is further configured to cause the UE to measure a radio channel, and wherein the first set of data is associated with the measurement of the radio channel.

20. The UE of claim 19, wherein the input data comprises at least one of a measured channel matrix of the radio channel and a precoder for the radio channel.
